(19) United States
(12) Patent Application Publication
(10) Pub. No.: US 2006/0291444 A1
(43) Pub. Date: Dec. 28, 2006

(54) Method and apparatus for automatically selecting an RP

(76) Inventors: Daniel A. Alvarez, Pleasanton, CA (US); Yiqun Cai, Cupertino, CA (US)

Correspondence Address: CAMPBELL STEPHENSON ASCOLESE, LLP, 4807 SPICEWOOD SPRINGS RD., BLDG. 4, SUITE 201, AUSTIN, TX, 78759, US

(21) Appl. No.: 11/152,117

(22) Filed: Jun. 14, 2005

(51) Int. Cl. H04L 12/28

(52) U.S. Cl. 370/351

(57) ABSTRACT

An apparatus or method for selecting a rendezvous point (RP) for a multicast group or a range of multicast groups. In one embodiment, the method includes an RP enabled device receiving a plurality of advertisements, wherein the plurality of advertisements comprise a plurality of IP addresses, respectively, for the RP enabled device creates a list, wherein the list comprises the plurality of IP addresses and an IP address of the RP enabled device. Thereafter an xth (e.g., first, third, fourth, etc.) IP address from the list is selected by the RP enabled device as the IP address for an active RP for the multicast group or range of multicast groups. After the RP enabled device selects the xth IP address, the RP enabled device can set up a forwarding state for the multicast group or any of the range of multicast groups without first advertising the selection of the xth IP address as the address for the RP.

### BACKGROUND OF THE INVENTION

Unicast and multicast are well-known techniques for transmitting data packets between sources and receivers via a packet-switched network consisting of one or more nodes. For purposes of explanation only, the term node will mean a router or a device that functions as a router, it being understood that the term node should not be limited thereto.

Unicast is a point-to-point communication technique in which data packets are transmitted within a network between a single source and a single receiver. Multicasting enables simultaneous transmission of data packets between a source or several sources and select receivers, i.e., those receivers belonging to a multicast group. During multicast transmission, multicast data packets are replicated by multicast enabled routers at points in the network where communication paths diverge to separate receivers. In this fashion, the multicast protocol delivers data to multiple receivers without burdening the source or consuming excessive network bandwidth.

In both unicast and multicast, a data packet may travel through a number of routers or hops in a network before arriving at its intended destination (i.e., the receiver). When a router receives a unicast data packet for subsequent transmission, the router decides which way to send it based on the packet's IP destination address and based on the router's current understanding of the state of the network to which it is connected. The state of the network is defined by a routing table which identifies currently available routes through which data packets can be successfully forwarded towards their destination.

Routing tables can take many forms, but in general each entry in a routing table has at least two fields—a first field containing an IP address for a device and a second field containing an identification of one of several interfaces of the router through which data packets can be transmitted towards the device with the IP address in the first field. Each router table entry may also contain a third field having information indicating whether the IP address of the first field is reachable through the router interface identified in the second field. It is noted that the IP address in the first field may include a mask that defines a subnet that contains the IP address.

Routers use their routing tables to compute the next hop for each packet they receive during unicast transmission. More particularly, when a router receives a unicast data packet, the router looks up the destination IP address of the packet in its routing table. If the routing table contains an entry with an IP address that matches the IP destination address, and if the entry indicates that the matching IP address is reachable, the router transmits the received data packet out of the router's interface identified within that routing table entry. Otherwise, the received unicast data packet is dropped.

Multicast routing is substantially different from unicast routing. In multicast, routers in the network build a distribution tree (more fully described below) through which multicast data packets flow to receivers of a multicast group. Multicast data packets travel down the distribution tree towards the receivers, and when the distribution tree branches at a router, the router replicates the data packets and sends them down each branch towards respective receivers.

Multicast enable routers use routing tables to set up a forwarding state in the opposite direction of unicast, from receiver to the root of the distribution tree. In multicast, the root of the distribution tree can be the source or a rendezvous point (more fully described below) router. When setting up a forwarding state, the router performs a reverse path forwarding (RPF) check. More particularly, the router accesses its routing table using the known IP address of the distribution tree root to determine the RPF interface, i.e, the interface through which the router should receive data packets for receivers of the multicast group.

There are several different multicast protocols, including but not limited to protocol independent multicast (PIM) sparse mode (SM), and bidirectional PIM. The present invention will be described with reference to PIM-SM, it being understood that the present invention should not be limited thereto. PIM-SM may be defined in Internet Engineering Task Force Request for Comments 2362 entitled “Protocol Independent Multicast-Sparse Mode: Protocol Specification,” published in June 1998, and hereby incorporated by reference in its entirety. Subsequent revisions of this specification are also incorporated herein by reference in their entirety.

In PIM-SM multicast, receivers of a multicast group receive multicast data packets from one or more sources via a root of a shared distribution tree. In PIM-SM multicast communication the root of a shared distribution tree is known as a rendezvous point (RP). Routers typically function as RPs for multicast communication, and the present invention will be described with reference to a router acting as an RP it being understood that the present invention should not be limited thereto.

To forward multicast data packets down the shared distribution tree, the RP router itself must first receive the multicast data packets from one or more sources. A host which seeks to join a multicast group as a source must first register with the RP router for the multicast group before the host can begin sending traffic to receivers of the multicast group. Although a router can function as the RP for several distinct multicast groups, the present invention will be described with reference to a router acting as the RP for one multicast group G, it being understood that the present invention should not be limited thereto. Because sources register with the RP router, the RP router is aware of all sources for the multicast group. In a sense, the RP router acts like a meeting place for sources and receivers of multicast data.

PIM-SM enabled routers (other than the RP router) do not know the IP address of the source or sources transmitting data to receivers of a multicast group when creating a forwarding state for a multicast group. However, the routers know the IP address of the RP router for each multicast group as will be more fully described below. When a last hop router learns that a host connected to it seeks to join a multicast group G as a receiver, the last hop router tries to join the shared distribution tree for multicast group G (assuming the last hop does not have a forwarding state for multicast group G). In this regard, the last hop router performs an RPF check using the known IP address of the RP router for multicast group G. The routing table used for RPF checks can be the same routing table used to forward unicast data packets, or it can be a separate routing table dedicated to multicast RPF. If the same routing table used to forward unicast data packets is used for RPF, it is created and updated by traditional unicast routing protocols (RIP, etc.). If a dedicated multicast RPF table is used, it must be created and updated by some other means.

The RPF check yields the incoming interface (the RPF interface) that is topologically closest (in terms of the number of hops) to the RP router for multicast group G. The last hop router joins toward the RP router by sending a (*, G) Join control packet out from the RPF interface identified by the RPF check. The “*” is a wildcard used in PIM-SM to identify any source that is transmitting data to receivers of multicast group G. Each upstream router towards the RP repeats this process of sending (*, G) Joins out of their respective RPF interface until this new branch of the shared distribution tree either reaches the RP router or reaches a router that already has a multicast forwarding state for the multicast group G. In this way, a new branch of the shared distribution tree is created for the host seeking to join multicast group G as a receiver.

As noted above, PIM-SM networks establish a shared distribution that is rooted at the RP router. The IP address for the RP router must be known before a forwarding state can be formed at a router. FIG. 1 and the following text illustrate this concept more completely. More particularly, FIG. 1 is a block diagram illustrating a PIM-SM network 10 connected to hosts 12a-12f. Network 10 includes multicast enabled routers 14a-14f coupled to each other via communication links (e.g., serial T1 lines) 16a-16h. Hosts 12a-12f are coupled to network 10 via communication links (e.g., Ethernet lines) 18a-18d as shown. Presume that router 14b is designated within network 10 as the RP router for a multicast group G to which hosts 12a and 12g send data as sources.

Presume further that host 12e seeks to join multicast group G as a receiver. Host 12e can join multicast group G by first generating a membership report in compliance with internet management group protocol (IGMP). The multicast group address G is included in the IGMP membership report. The IGMP membership report is transmitted by host 12e to it's last hop router 14f via communication link 184c. For purposes of illustration, presume that router 14f does not have a forwarding state for multicast group G when router 14f receives the IGMP report from host 12e. Router 14f, however, does know the IP address of RP router 14b. Router 14f sets up an outgoing interface list for multicast group G, and adds the interface on which it received the IGMP membership report from host 12e. Router 14f also performs an RPF check of its routing table using the known IP address of RP router 14b. This check yields the RPF interface that leads to RP router 14b. Router 14f generates and transmits a (*, G) Join control packet out the RPF interface toward RP router 14b. More particularly, the (*, G) Join is sent out the interface coupled to communication link 16g. Router 14d receives the (*, G) Join and adds the interface on which it received the (*, G) Join to its outgoing interface list for multicast group G. Presume that router 14d has a forwarding state for multicast group G. As such, there is no need for router 14d to perform an RFP check for the IP address of RP router 14b. Any multicast packet received by router 14d from RP router 14b for multicast group G is forwarded by router 14d to router 14f according to router 14d's outgoing interface list, and any multicast packet received by router 14f for multicast group G is forwarded to receiver 12e in accordance with router 14f's outgoing interface list. It is noted that router may forward to host 12e the datagrams contained within respective multicast packets received from router 14d rather than the multicast packets themselves.

As seen above, routers within the PIM-SM enabled network 10 must know the IP address for RP router 14b to set up a forwarding state for multicast traffic. Routers can learn the IP address for the RP routers in one of several ways. The IP address for the RP router 14b can be manually programmed into each router 14a-14f of the network. Alternatively, each router within network 10 can learn the IP address of RP router 14b using a known protocol such as Auto-RP. In Auto-RP, several routers of network 10 are configured as candidate RPs for a multicast group. These candidate RPs periodically advertise themselves to one router in the network that is designated as a mapping agent. The mapping agent receives the advertisements from the candidate RPs, which advertisements identify the candidate RPs by their respective IP addresses. The mapping agent creates a list of candidate RPs from the received advertisements and selects one which has the highest IP address as the active RP for the multicast group. Thereafter, the mapping agent advertises the IP address of the active RP router throughout the network. All routers within the network learn the IP address of the active RP router when they receive the advertisement from the mapping agent. This process is repeated at frequent intervals so that the identity of the active RP router within each router is kept current.

RP routers, like any other device within a network may fail. Because the Auto-RP mapping agent uses the highest IP address of candidate RP's to select the active RP router for the multicast group, Auto-RP enables a redundant RP in the event of active RP failure. In other words, if the active RP fails, the candidate RP with the next highest IP address will be selected and advertised by the mapping agent as the new, active RP.

Auto-RP works well in static networks, or networks whose structure or addressing does not change. Problems, however, can arise when Auto-RP is employed in ad hoc or relocatable networks that lack a strict structure. To illustrate, presume router 14c in FIG. 1 is the Auto-RP mapping agent for multicast group G. Periodically (e.g., every 60 seconds) mapping agent 14c receives advertisements from each candidate RP router, including router 14b, within network 10. Thereafter, mapping agent 14c advertises the IP address for router 14b through out network 10 as the RP for multicast group G since router 14b is presumed to have the highest IP address of all candidate RP routers.

Suppose network 10 of FIG. 1 reconfigures into two isolated networks as shown in FIG. 2 soon after router 14b is selected as the active RP for multicast group G. Routers within network 10a are not reachable by routers in network 10b, and vice versa. This isolation of routers presents several problems. For example, the RP router for multicast group G is isolated in network 10a, which results in a loss of connectivity between sources and receivers in network 10b of multicast group G. More particularly, receivers of multicast group G which are coupled to network 10b cannot receive multicast data since the active root (i.e., RP router 14b) for multicast group G is in network 10b. This is true even though a source for multicast group G may be coupled to network 10b. Another problem is the lack of a mapping agent 14c in network 10b. Without a mapping agent, a shared distribution tree for multicast group G cannot be reestablished in network 10b. This is true even though one or more of the routers in network 10b periodically advertise themselves as candidate RPs for multicast group G.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a block diagram illustrating relevant components of a packet-switched network;

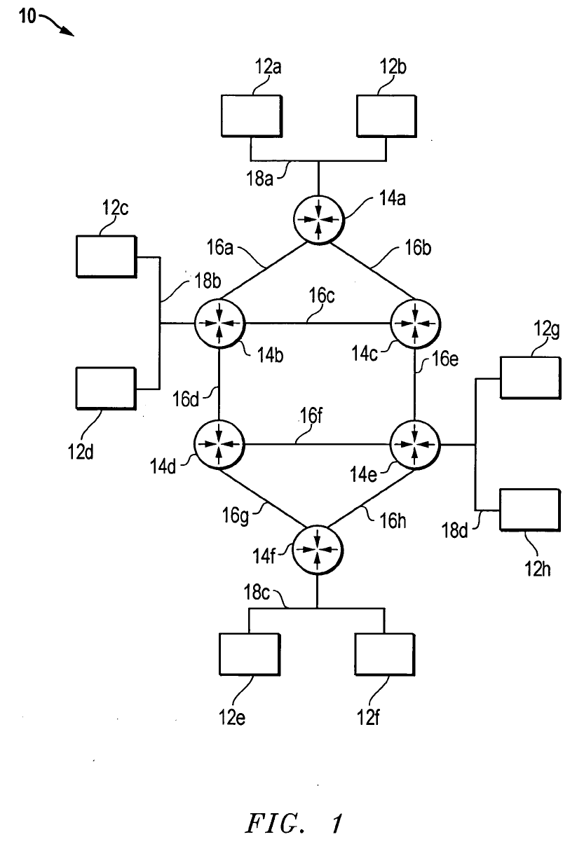

FIG. 2 shows the packet-switched network of FIG. 1 after reconfiguration thereof;

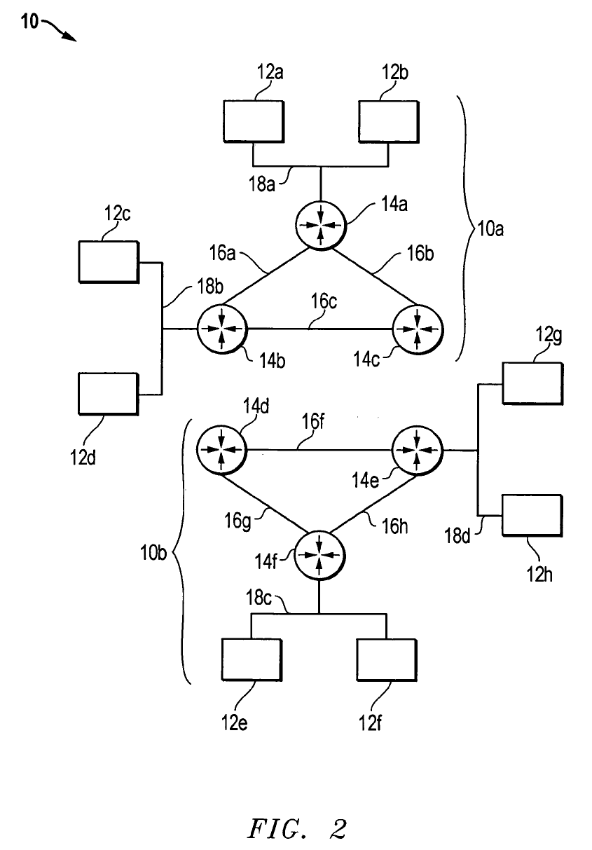

FIG. 3 illustrates a block diagram illustrating relevant components of a packet-switched network employing one embodiment of the present invention;

FIGS. 4a-4d illustrate exemplary reachable loopback address lists employed in accordance with one embodiment of the present invention;

FIG. 5 shows the packet-switched network of FIG. 3 after reconfiguration thereof;

FIG. 6 illustrates relevant components of a router.

The use of the same reference symbols in different drawings indicates similar or identical items.

### DETAILED DESCRIPTION

The following description describes an apparatus or method for selecting an RP for a multicast group or a range of multicast groups. The present invention will be described with reference to selecting a router as the RP for a multicast group, it being understood that the present invention should not be limited thereto. The present invention may be used to select any device as the RP for a multicast group so long as the device can operate as an RP for the multicast group. The present invention will be described with reference to a network employing IPv4, it being understood that the present invention may be implemented in a network employing IPv6.

The present invention can be employed in one or more routers or other devices (e.g., a general purpose of special purpose computer) which are configured to perform routing functions. Embodiments within the scope of the present invention also include computer readable media that stores computer executable instructions, which when executed perform the function of selecting a router as the RP for a multicast group. Such computer readable media can be any available media which can be accessed by a processor within a router or other device (e.g., a general purpose or special purpose computer). By way of example, and not limitation, such computer readable media can comprise RAM, ROM, EEPROM, CD-ROM or other optical disk storage, magnetic disk storage or other magnetic storage devices, magneto-optical storage devices, or any other medium which could be used to store executable instructions which can be accessed directly or indirectly by a processor or executing instructions. Combinations of the above should also be included within the scope of the computer readable media. Registers of a CPU or other processing unit that store computer executable instructions while decoding and executing the same are also included within the scope of the computer readable media. Lastly, the present invention also contemplates application specific integrated circuits that perform inventive functions described herein.

To maintain multicast connectivity between sources and receivers it may be necessary to select a new, active RP router for a multicast group if a previous, active RP router for the multicast group suddenly becomes unavailable. While Auto-RP may provide redundant RP router capabilities across a few routers in a PIM-SM network as described above, Auto-RP may not provide redundant RP router capabilities across all routers within the PIM-SM network after a reconfiguration thereof. For example, the reconfiguration of network 10 described above into networks 10a and 10b leaves network 10b without connectivity to an RP router for multicast group G. In some networks it may be necessary to maintain connectivity across a portion of the PIM-SM network isolated after a change, even when the isolated PIM-SM network includes a single router. As such, some networks (i.e., ad hoc or relocatable networks) may require that every router is capable of being selected to perform RP duties if necessary.

In maintaining connectivity between multicast sources and receivers after a network reconfiguration, each router selects a reachable candidate RP router as the active RP for multicast group G. One way of doing this is providing each router with a sorting algorithm which selects the same reachable, candidate RP router as the active RP router. Unicast routing tables can define which candidate RP routers are reachable.

In one embodiment of the present invention, each router in a network is configured as a candidate RP for the multicast group. Each of these candidate routers is assigned an IP address that falls within a range of IP addresses, each of which has an identical prefix. In other words, each of the routers is assigned an IP address that falls within a subnet range of addresses. The subnet range of addresses will be referred to as the RP range of addresses.

In a preferred embodiment, the IP addresses assigned to the routers that fall within the RP range, will be loopback addresses. Thus, in the preferred embodiment of the present invention, each router is assigned a loopback address that falls within the RP range of addresses. A loopback address is a special address that is designated for a software loopback interface of a machine (e.g., a router). The loopback interface has no hardware associated with it, and it is not physically connected to a network. A loopback interface allows IP professionals to test IP software.

Each router advertises its assigned loopback address via the available IGP (without summarization). Each router creates and maintains a sorted list of reachable loopback addresses (RLAs) it receives via advertisements. In one embodiment, the RLA list can be created in part by extracting all RLAs from the router's Unicast routing table that fall within the RP range. Each router will add its own loopback address to its RLA list. It is noted that the RLA list in each of the routers of the network may or may not be identical to each other as will be more fully described below.

The RLAs are stored in each RLA list in order from the RLA having the highest numerical value to the RLA having the lowest numerical value, or vice versa. For purposes of explanation, it will be presumed that the RLAs in each RLA list are sorted in order from the RLA having the highest numerical value to the RLA having the lowest numerical value.

Each of the routers implements an algorithm that selects the xth numbered RLA from its respective RLA list as the IP address for the active RP router for multicast group G. For example, each router may select the first RLA in its respective RLA list as the IP address of the RP router for the multicast group G. Alternatively, each router may select the third RLA in its respective RLA list as the IP address of the RP router for the multicast group G. In still another embodiment, each router may select the last RLA in its respective RLA list as the IP address of the RP router for the multicast group G. Regardless of the RLA selected from the RLA list, the routers do not advertise the IP address of the router selected as the RP of the multicast group G.

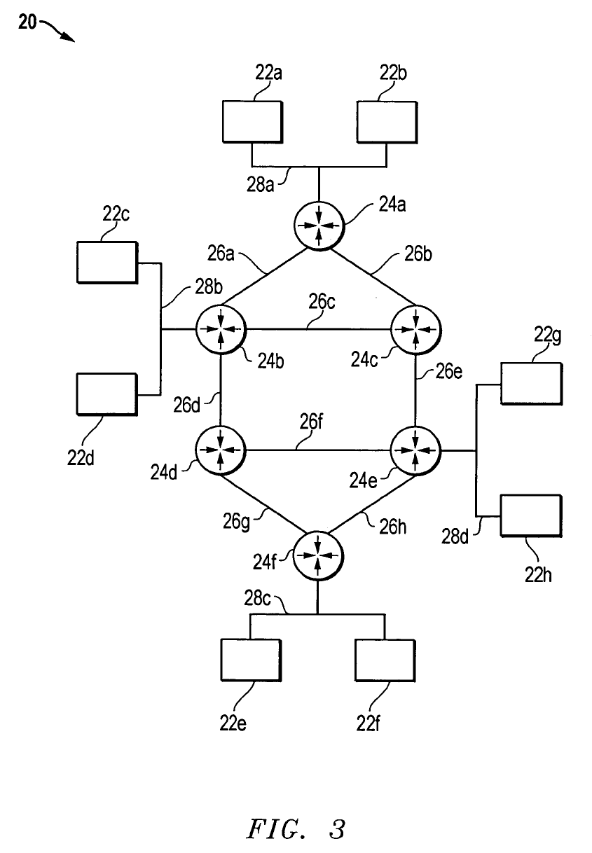

FIG. 3 illustrates in block diagram form a network 20 employing an exemplary embodiment of the present invention. FIG. 3 shows a PIM-SM enabled network 20 coupled to hosts 22a-22f. Network 20 includes multicast enabled routers 24a-24f coupled to each other via communication links (e.g., serial T1 lines) 26a-26h and to hosts 22a-22f via communications links (e.g., Ethernet lines) 28a-28d. Each of the routers 22a-22f is configured as a candidate RP for multicast group G.

Each of the routers 22a-22f is assigned a loopback address that falls within a range of addresses, each of which has an identical prefix. In other words, each of the routers 22a-22f is assigned a loopback address that falls within an RP range of addresses. Table 1 below shows exemplary loopback addresses assigned to routers 24a-24f.

TABLE 1

| Loopback Address | Router |
|---|---|
| 1.1.1.1/32 | 24a |
| 1.1.1.2/32 | 24c |
| 1.1.1.3/32 | 24e |
| 1.1.1.4/32 | 24f |
| 1.1.1.5/32 | 24d |
| 1.1.1.6/32 | 24b |

As seen in table 1 each of the exemplary loopback addresses fall within an exemplary RP range 1.1.1.0/24, where 1.1.1 defines the common prefix of the loopback addresses and 24 defines the subnet mask.

Each router 24a-24f advertises its assigned loopback address to the other routers that are reachable within network 20 of FIG. 3. In one embodiment, each router 22a-22f creates or updates a sorted list of RLAs it receives via advertisements from the other routers that fall within the RP range (e.g., 1.1.1.0/24). Each router will include its own loopback address in the RLA list.

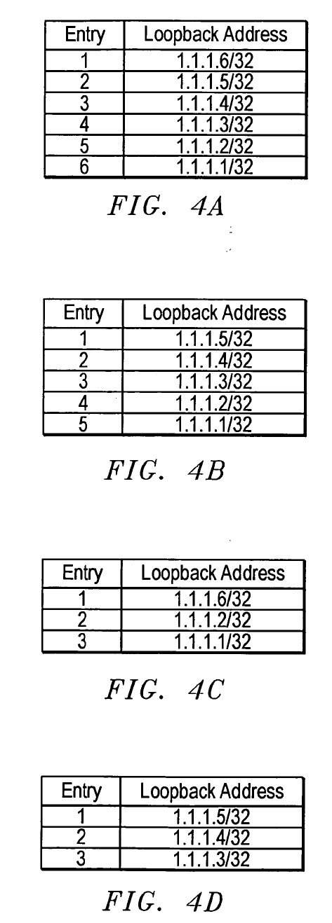

Since all of the routers 22a-22f in FIG. 3 are reachable to each other, the routers 22a-22f will create identical RLA lists or update their RLA lists to be identical. FIG. 4a illustrates the RLA list created or updated by each of the routers 22a-22f. It is noted that each router updates its Unicast routing table with the loopback addresses received in advertisements from other routers, and that the Unicast routing table can be used to identify reachable loopback addresses to be included in the RLA lists.

As noted above, each of the routers 22a-22f implements an algorithm to select the IP address of the active RP router for the multicast group G. The present invention will be described with the algorithm executing within each router selecting the RP corresponding to the first RLA in the router's respective RLA list, it being understood that the present invention should not be limited thereto. As such, each of the routers selects 1.1.1.6/32 as the IP address of the RP for multicast group G since 1.1.1.6/32 is the first address in each of the RLA lists (see FIG. 4).

The process of (1) advertising a loopback address, (2) creating or updating a sorted RLA list, and (3) selecting the first loopback address in the RLA list as the IP address of the active RP for multicast group G is performed periodically by each of the routers in FIG. 3. If the selected active RP router suddenly loses reachability, the loopback address for that unreachable router will be removed from the sorted lists of RLAs the next time the routers update their respective RLA lists. Thereafter, each router will select the first loopback address in its updated RLA list and designate the corresponding router as the new, active RP for multicast group G. In this fashion all routers within network 20 will converge to the new, active RP router as soon as the RLA lists reconverge to account for the loss of the prior, active RP router for multicast group G.

To illustrate, suppose there is a failure in communication links 16a, 16c, and 16d, such that router 14b is no longer reachable by routers 14a and 14c-14f. Router 14b is assigned loopback address 1.1.1.6/32 and was selected as the RP router of multicast group G in the example above. After failure of communication links 16a, 16c, and 16d, the routers 14a-14f within network 20 again advertise their respective loopback addresses. Each of the routers subsequently updates its respective RLA list using the loopback addresses of the received advertisements that fall within the RP range 1.1.1.0/24. Because routers 14a and 14c-14f do not receive an advertisement from router 14b, loopback address 1.1.1.6/32 will not be included in the updated RLA lists for routers 14a and 14c-14f. FIG. 4b illustrates the updated RLA list for routers 14a and 14c-14f. As can be seen, the loopback address for router 14b is not included within the RLA list shown in FIG. 4b. Eventually, each of the routers of 14a and 14c-14f select router 14d as the new, active RP router for multicast group G since the loopback address 1.1.1.5/32 for router 14d is the first loopback address in the RLA list in each of the routers 14a and 14c-14f.

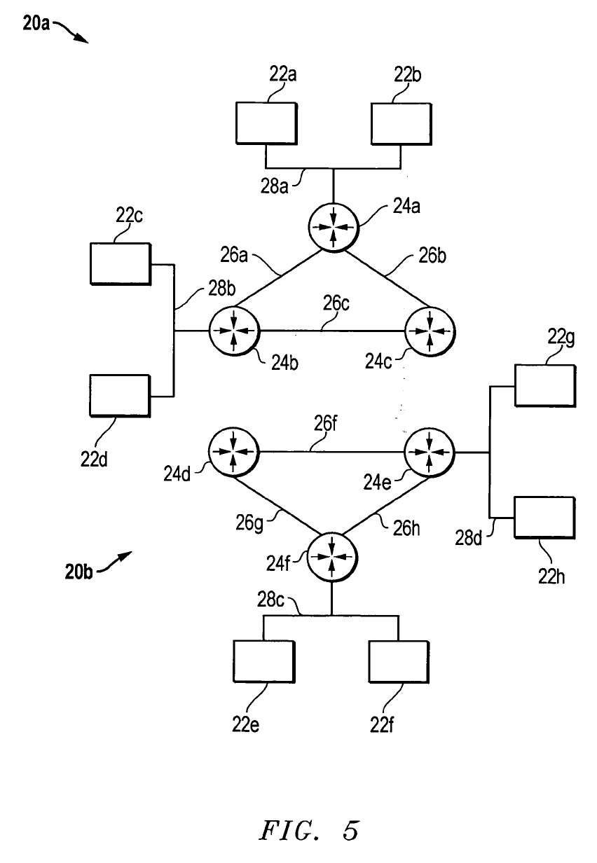

The present invention also addresses reconfiguration concerns described above in the background section. To illustrate, presume that network 20 shown in FIG. 3 reconfigures into networks 20a and 20b as shown in FIG. 5. All routers 24a-24f in FIG. 5 are functioning, but the communication links 26d and 26d shown within FIG. 3 have been removed such that routers 24a-24c are no longer reachable by routers 24c-24f, and vice versa. Soon after reconfiguration of network 20 into networks 20a and 20b, each of the routers 24a-24f advertise their respectively assigned loopback addresses. Thereafter, each of the routers 24a-24f update their respective RLA list. FIG. 4c illustrates the updated RLA list for routers 24a-24c, while FIG. 4d illustrates the updated RLA list for routers 24d-24f.

The RLA list in FIG. 4c shows that routers 24d-24f are not reachable by routers 24a-24c since the unicast routing tables for routers 24a-24c will not contain the loopback addresses for routers 24d-24f, and FIG. 4d shows that routers 24a-24c are not reachable by routers 24d-24f since the unicast routing tables for routers 24d-24f will not contain the loopback addresses for routers 24a-24c. Eventually, each of the routers 24a-24f select the first loopback address in its respective RLA list as the IP address of the active RP for multicast group G. Thus, each of routers 24a-24c select router 24b as the RP router for multicast group G since the loopback address 1.1.1.6/32 assigned to router 24b is the first loopback address in each of the RLA lists for routers 24a-24c. In contrast, routers 24d-24f select router 24d as the RP router for multicast group G since the loopback address 1.1.1.5/32 for router 24d is the first loopback address in the RLA list for routers 24d-24f. Because networks 20a and 20b have their own RP router, hosts 22a-22d can communicate with each other via multicast group G, and hosts 22e-22h can communicate with each other via multicast group G even though networks 20a and 20b are isolated from each other.

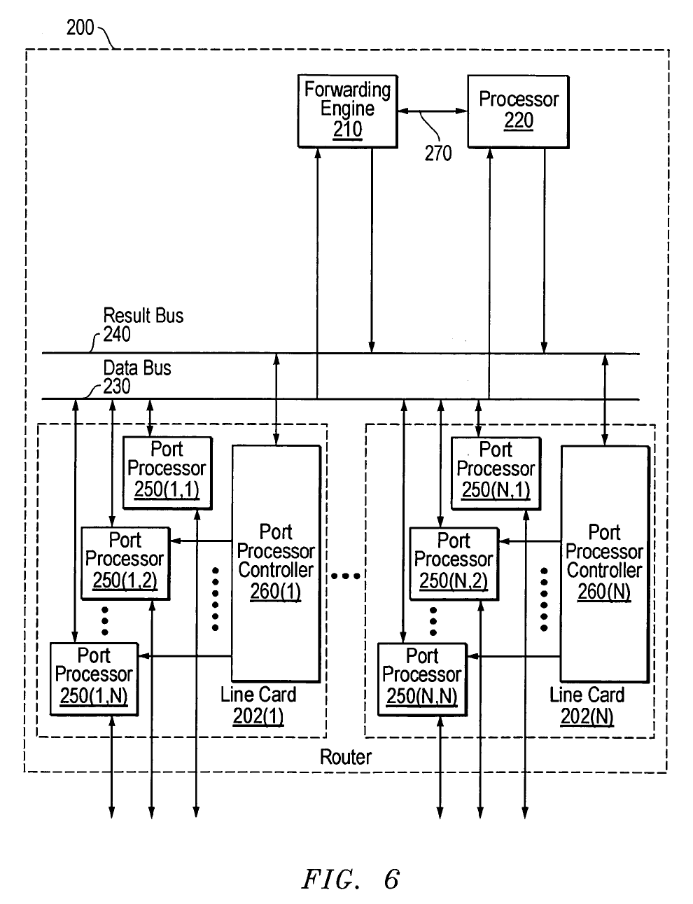

FIG. 6 is a block diagram illustrating relevant components of an exemplary router 200 that can implement one or more of the methods described above. Router 200 includes two or more line cards 202 that are communicatively coupled to a forwarding engine 210 and a processor 220 via a data bus 230 and a result bus 240. Although not shown, router 200 may include a memory for storing the router's RLA list. Each of line cards 202 may include one or more port processors 250 which are controlled by port processor controllers 260. It will also be noted that forwarding engine 210 and processor 220 are not only coupled to one another via data bus 230 and result bus 240, but are also communicatively coupled to one another by a communications link 270.

When a packet is received by a line card 202, the packet may be identified and analyzed in the following manner. The packet (or some or all of its control information) is sent from the receiving port processor 250 to one or more devices coupled to data bus 230 (e.g., another port processor, forwarding engine 210 and/or processor 220). Handling of the received packet can be determined by forwarding engine 210. For example, forwarding engine 210 may determine that the received packet should be forwarded to one or more of port processors 250. This can be accomplished by indicating to corresponding one or more port processor controllers 260 that a copy of the received packet should be forwarded to one or more appropriate port processors 250.

In the foregoing process, network security information can be included in a frame sourced by router 200 in a number of ways. For example, forwarding engine 210 can be used to detect the need for the inclusion of network security information in the packet, and processor 220 can be called into service to provide the requisite network security information. This network security information can be included in the packet during the transfer of the packet's contents from one port processor 250 to another port processor 250, by processor 220 providing the requisite information directly, or via forwarding engine 210, for example. The assembled packet can thus be made to contain the requisite network security information.

In addition, or alternatively, once a packet has been identified for processing, forwarding engine 210, processor 220 or the like can be used to process the packet in some manner or add packet security information, in order to secure the packet. On a node sourcing such a packet, this processing can include, for example, encryption of some or all of the packet's information, the addition of a digital signature or some other information or processing capable of securing the packet. On a node receiving such a processed packet, the corresponding process is performed to recover or validate the packet's information that has been thusly protected.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
a first router storing a plurality of IP addresses in a first memory, wherein each of the plurality of IP addresses correspond to a respective RP enabled router;
a second router storing the plurality of IP addresses in a second memory;
the first router selecting a first IP address from the plurality of IP addresses stored in the first memory;
the second router selecting a second IP address from of the plurality of IP addresses stored in the second memory;
wherein the first IP address is identical to the second IP address.

2. The method of claim 1 further wherein each of the plurality of IP addresses is contained in a subnet range of addresses.

3. The method of claim 1 wherein each of the plurality of IP addresses comprises an identical prefix.

4. The method of claim 1 further comprising an act of assigning the plurality of IP addresses to the plurality of RP enabled routers, respectively, before the first router selects one of the plurality of IP addresses.

5. The method of claim 3 wherein each of the plurality of IP addresses comprises a respective loopback address.

6. The method of claim 1 further comprising:
the first router receiving a first PIM-SM Join after selecting the first IP address;
the first router forwarding the PIM-SM Join towards one of the plurality of RP enabled routers that corresponds to the first IP address;
the second router receiving a second PIM-SM Join after selecting the second IP address;
the first router forwarding the second PIM-SM Join towards the one of the plurality of RP enabled routers that corresponds to the second IP address.

7. The method of claim 5 further comprising:
the first router generating and transmitting a first advertisement, wherein the first advertisement comprises a loopback address assigned to the first router and contained within a range of the subnet addresses;
the second router generating and transmitting a second advertisement, wherein the second advertisement comprises a loopback address assigned to the second router and contained within the subnet range of addresses, wherein the loopback address assigned to the first router is different from the loopback address assigned to the second router.

8. The method of claim 1 further comprising:
the first router sorting in numerical order the plurality of IP addresses stored in the first memory to create a first sorted list;
wherein the first IP address is an xth IP address in the first sorted list;
the second router sorting in numerical order the plurality of IP addresses stored in the second memory to create a second sorted list;
wherein the second IP address is the xth IP address in the second sorted list.

9. An apparatus comprising:
a first packet-switched network comprising a plurality of first nodes, each of which is configured to operate within the first packet-switched network as an RP for a multicast group G, wherein the plurality of first nodes are assigned a plurality of first IP addresses, respectively;
wherein each of the plurality of first nodes is configured to select one IP address from the plurality of first IP addresses;
wherein each of the plurality of first nodes is configured to transmit (*,G) Joins towards the selected one IP address after each of the plurality of first nodes selects the one IP address.

10. The apparatus of claim 9 further comprising:
a second packet-switched network comprising a plurality of second nodes, each of which is configured to operate within the second packet-switched network as an RP for the multicast group G, wherein the plurality of second nodes are assigned a plurality of second IP addresses, respectively;
wherein each of the plurality of second nodes is configured to select one IP address from the plurality of second IP addresses;
wherein each of the plurality of second nodes is configured to transmit (*,G) Joins towards the one IP address selected from the plurality of second IP addresses after each of the plurality of second nodes selects the one IP address from the plurality of second IP addresses.

11. The apparatus of claim 10 wherein each of the plurality of first and second IP addresses comprises an identical prefix.

12. The apparatus of claim 10 wherein each of the plurality of first and second IP addresses is contained within a subnet range of addresses.

13. The apparatus of claim 10 wherein each of the plurality of first and second IP addresses comprises a respective loopback address.

14. The apparatus of claim 9 wherein each of the plurality of first nodes is configured to transmit (*,G) Joins towards the selected one IP address without first advertising the selected one IP address.

15. The apparatus of claim 10 wherein each of the plurality of second nodes is configured to transmit (*,G) Joins towards the one IP address selected from the plurality of second IP addresses without first advertising the one IP address selected from the plurality of second IP addresses.

16. An apparatus comprising:
means for receiving a plurality of advertisements, wherein the plurality of advertisements comprise a plurality of IP addresses, respectively, for a plurality of RP enabled devices, respectively;
means for creating a list, wherein the list comprises the plurality of IP addresses and an IP address of the apparatus;
means for selecting an xth IP address from the list.

17. An apparatus comprising:
a first circuit for creating a list in response to the router receiving a plurality of advertisements, wherein the plurality of advertisements comprise a plurality of IP addresses, respectively, for a plurality of RP enabled devices, respectively, wherein the list comprises the plurality of IP addresses and an IP address of the apparatus;
a second circuit for selecting an xth IP address from the list.

18. The apparatus of claim 17 further comprising a third circuit for transmitting a PIM-SM Join towards the xth IP address selected from the list.

19. The apparatus of claim 17 wherein the plurality of IP addresses and the IP address of the RP enabled device are contained within a subnet range of IP addresses.

20. A method comprising:
a first RP enabled router receiving a plurality of advertisements, wherein the plurality of advertisements comprise a plurality of IP addresses, respectively, for a plurality of RP enabled devices, respectively;
the first RP enabled router creating a list in memory, wherein the list comprises the plurality of IP addresses and an IP address of the apparatus;
the first RP enabled router selecting an xth IP address from the list.

21. The method of claim 20 further comprising the first RP enabled router transmitting a PIM-SM Join towards the xth IP address selected from the list.

22. The method of claim 21 wherein the plurality of IP addresses and the IP address of the first RP enabled router are contained within a subnet range of IP addresses.
